(19) United States
(12) Patent Application Publication
(10) Pub. No.: US 2016/0191492 A1
(43) Pub. Date: Jun. 30, 2016

(54) METHOD AND DEVICE FOR TRANSFERRING RESOURCES

(71) Applicant: Xiaomi Inc., Beijing (CN)

(72) Inventors: Min Shang, Beijing (CN); Zhencai Shu, Beijing (CN); Pengfei Chen, Beijing (CN)

(21) Appl. No.: 14/800,711

(22) Filed: Jul. 16, 2015

Related U.S. Application Data
(63) Continuation of application No. PCT/CN2015/077858, filed on Apr. 29, 2015.

(30) Foreign Application Priority Data
Dec. 27, 2014 (CN) 201410829482.1

(51) Int. Cl. H04L 29/06

(52) U.S. Cl. CPC H04L 63/083; H04L 63/126; H04L 63/0876

(57) ABSTRACT

The present disclosure discloses a method and a device for transferring resources. The method for transferring resources includes: receiving a resource transfer request for transferring resources sent by a transfer account; detecting whether a physical characteristic collected by a mobile device bound to the transfer account is received; and if detecting that the physical characteristic collected by the mobile device bound to the transfer account is received, transferring the resources when the physical characteristic matches with a stored physical characteristic model of the transfer account.

### CROSS-REFERENCE TO RELATED APPLICATIONS

This application is a Continuation of International Application No. PCT/CN2015/077858, filed Apr. 29, 2015, which is based upon and claims priority to Chinese Patent Application No. 201410829482.1, filed Dec. 27, 2014, the entire contents of which are incorporated herein by reference.

### TECHNICAL FIELD

The present disclosure relates to the field of computer technologies, and more particularly, to a method and a device for transferring resources.

### BACKGROUND

With the rapid development of e-commerce industry, it has become more and more popular for people to conduct operations such as transfer of recourses via an online network platform. The transfer of recourses refers to a process of transferring resources from a first resource library to a second resource library.

When the transfer of resources is carried out, various passwords, such as a transfer password, a login password, and a short message verification code, will be required to ensure the safety of transferring the resources. The resources that are requested to be transferred can only be transferred out of an account when a user inputs correct passwords.

### SUMMARY

According to a first aspect of embodiments of the present disclosure, there is provided a method for transferring resources, including: receiving a resource transfer request for transferring resources sent by means of a transfer account; detecting whether a physical characteristic collected by a mobile device bound to the transfer account is received; and if detecting that the physical characteristic collected by the mobile device bound to the transfer account is received, transferring the resources when the physical characteristic matches with a stored physical characteristic model of the transfer account.

According to a second aspect of embodiments of the present disclosure, there is provided a device for transferring resources, including: a processor; and a memory for storing instructions executable by the processor; herein the processor is configured to perform: receiving a resource transfer request for transferring resources sent by means of a transfer account; detecting whether a physical characteristic collected by a mobile device bound to the transfer account is received; and if detecting that the physical characteristic collected by the mobile device bound to the transfer account is received, transfer the resources when the physical characteristic matches with a stored physical characteristic model of the transfer account.

According to a third aspect of the embodiments of the present disclosure, there is provided a non-transitory readable storage medium including instructions, executable by a processor in a device, for performing a method for transferring resources, the method including: receiving a resource transfer request for transferring resources sent by means of a transfer account; detecting whether a physical characteristic collected by a mobile device bound to the transfer account is received; and if detecting that the physical characteristic collected by the mobile device bound to the transfer account is received, transferring the resources when the physical characteristic matches with a stored physical characteristic model of the transfer account.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a block diagram of an application scenario related to a method for transferring resources according to some exemplary embodiments.

FIG. 2 is a flow chart of a method for transferring resources according to an exemplary embodiment.

FIG. 3A is a flow chart of a method for transferring resources according to another exemplary embodiment.

FIG. 3B is a flow chart of binding a transfer account with a device identity according to an exemplary embodiment.

FIG. 3C is a flow chart of establishing and updating a physical characteristic model according to an exemplary embodiment.

FIG. 3D is a flow chart of abnormality prompting, according to an exemplary embodiment.

FIG. 4 is a block diagram of an apparatus for transferring resources according to an exemplary embodiment.

FIG. 5 is a block diagram of an apparatus for transferring resources according to another exemplary embodiment.

FIG. 6 is a block diagram of a device for transferring resources according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with some aspects related to the invention as recited in the appended claims.

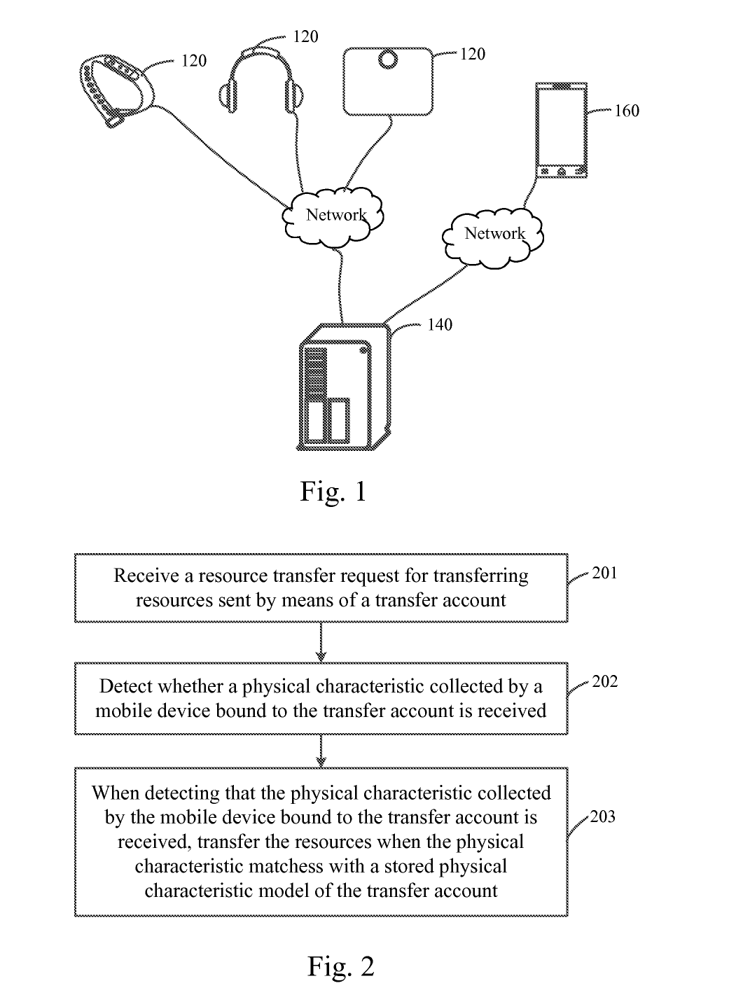

FIG. 1 is a block diagram of an application scenario related to a method for transferring resources according to some exemplary embodiments. As shown in FIG. 1, the application scenario may include at least a mobile device 120, a server 140, and a transfer requesting terminal device 160.

The mobile device 120 is usually provided with a sensor for collecting the physical characteristics of a user, such as a cardiac rate, a blood pressure, amplitude of arm swinging, a fingerprint, and face information. The mobile device 120 usually refers to a device that is frequently carried over or worn by the user, for instance, a device that can be worn on the body of the user such as a smart bracelet, a smart key ring, a smart watch, a smart tie clip, and a smart ring; in this way, the physical characteristics of the user can be collected at any time.

The transfer requesting terminal device 160 may be an electronic device for requesting to transfer resources. The electronic device may be a smart phone, a tablet, a smart TV, an e-book reader, a multimedia player, a portable laptop computer, and a desktop computer having a resource transfer function, and the like.

The server 140 may be respectively connected with the mobile device 120 and the transfer requesting terminal device 160 through a wired network or a wireless network.

The server 140 may receive the physical characteristic collected and sent in real time by the mobile device 120, receive a resource transfer request sent by the transfer requesting terminal device 160, and handle the resource transfer request according to the physical characteristic. The server 140 involved herein may be a single server, or a server cluster consisting of a plurality of servers, or a cloud computing service center. The server 140 may be a background payment server.

It is determined whether the resources requested to be transferred by the transfer requesting terminal device 160 can be transferred according to such information without a verification flow such as the use of a transfer password and the like.

FIG. 2 is a flow chart of a method for transferring resources according to an exemplary embodiment. As shown in FIG. 2, the method for transferring resources is applied in the server 140 in the application scenario as shown in FIG. 1, including the following steps.

In step 201, a resource transfer request for transferring resources sent by means of a transfer account is received.

In step 202, whether a physical characteristic collected by a mobile device bound to the transfer account is received is detected.

In step 203, if detecting that the physical characteristic collected by the mobile device bound to the transfer account is received, the resources are transferred when the physical characteristic matches with a stored physical characteristic model of the transfer account.

When detecting that the physical characteristic collected by the mobile device bound to the transfer account is received, the server may calculate a matching degree between the physical characteristic and the stored physical characteristic model of the transfer account. When the calculated value of the matching degree is greater than a predetermined matching threshold, the physical characteristic is determined as matching with the stored physical characteristic model of the transfer account.

In conclusion, according to the method for transferring resources provided in the embodiments, while receiving the transfer resource request of the transfer account, if detecting that the received physical characteristic matches with the physical characteristic model of the transfer account within the predetermined time period, the requested resources are transferred. Since the server may match the received physical characteristic with the physical characteristic model, and directly transfer the resources after successful matching, the problem of complex resource transfer flow caused by various passwords used for ensuring the resource transfer security during the resource transfer process is solved, and the effect of reducing the complexity of the resource transfer flow while ensuring the security is achieved.

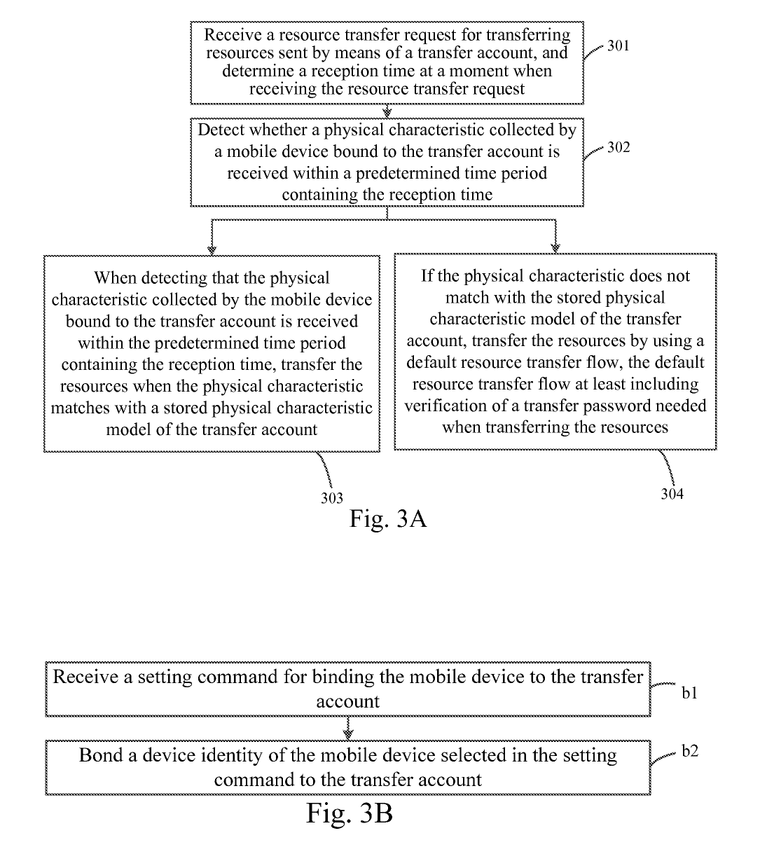

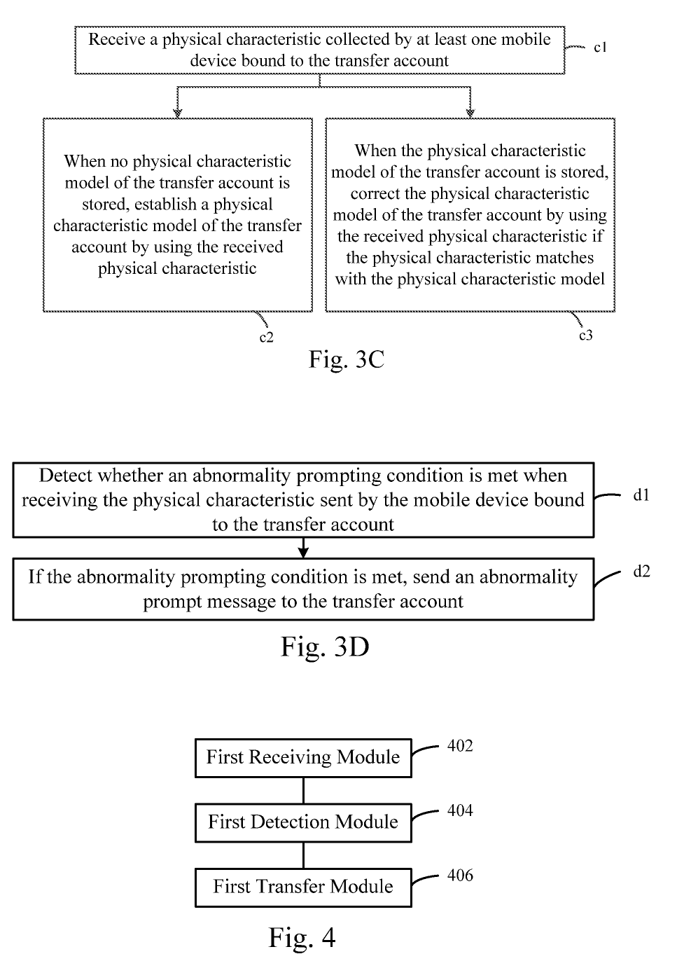

FIG. 3A is a flow chart of a method for transferring resources according to another exemplary embodiment. As shown in FIG. 3A, the method for transferring resources is applied in the server 140 in the application scenario as shown in FIG. 1, including the following steps.

In step 301, a resource transfer request for transferring resources sent by means of a transfer account is received, and a reception time at a moment when receiving the resource transfer request is determined.

A server, when receiving the resource transfer request for transferring resources sent by means of the transfer account, may record the time at the moment when receiving the resource transfer request, i.e., the reception time.

Optionally, the resource transfer request carries the transfer account therein.

Optionally, the resource transfer request is sent by the transfer requesting terminal device 160 in the application scenario of FIG. 1. For example, when a user logs in to the transfer account at the transfer requesting terminal device 160, and requests to transfer some resources under the transfer account, the transfer requesting terminal device 160 may send a resource transfer request under the control of the user to the server, the resource transfer request carrying the transfer account and a resource value corresponding to the resource to be transferred. Usually, the resource transfer request further includes an identity of a first resource library in which the resources that the resource value corresponds to is located, and an identity of a second resource library to which the resources will be transferred. That is, the resource transfer request is usually used for indicating that the transfer account requests to transfer the resources having a predetermined resource value in the first resource library to the second resource library.

In practical applications, the information carried in the resource transfer request may be set according to the actual application scenarios, and will not be concretely defined in the embodiment.

In step 302, whether a physical characteristic collected by a mobile device bound to the transfer account is received within a predetermined time period containing the reception time is detected.

In practical implementation, a sensor may be provided on the mobile device. The sensor may be configured to collect some physical characteristics of the user, wherein the physical characteristics may include a cardiac rate, a blood pressure, an amplitude and frequency of arm swinging, fingerprint information, face information, weight information, and the like. For example, some sensors may collect the cardiac rate of the user, some may collect the blood pressure of the user, and some may collect the amplitude and frequency of arm swinging of the user while the user is walking Optionally, the physical characteristics collected by different mobile devices may be different. Optionally, one mobile device may collect at least one physical characteristic.

Optionally, when the mobile device collects the physical characteristic, the mobile device may send the collected physical characteristic to the server at predetermined time intervals or in real time. Accordingly, the server may receive the physical characteristic collected by the mobile device. The predetermined time interval herein may be set according to actual needs. When the physical characteristics are needed to be frequently sent to the server so as to ensure or improve the security while transferring resources, the predetermined time interval may be set to be relatively small. When network status between the server and the mobile device is poor, the predetermined time interval may be set to be relatively large. The value of the predetermined time interval will not be limited in the present disclosure.

The step of the server detecting whether the physical characteristic collected by the mobile device bound to the transfer account is received within the predetermined time period containing the reception time, includes the following steps.

First, a device identity of the mobile device bound to the transfer account is determined.

A binding relationship between the device identity of the mobile device and the transfer account may be stored in the server. When the server receives the resource transfer request sent by the transfer account, the device identity bound to the transfer account may be found according to the stored binding relationship.

Optionally, the server may also acquire the stored binding relationship between the device identity of the mobile device and the transfer account from other devices or servers, and find the device identity bound to the transfer account according to the acquired binding relationship when receiving the resource transfer request sent by the transfer account.

Optionally, the server may also send a search request to other device or server that stores the binding relationship between the device identity of the mobile device and the transfer account when receiving the resource transfer request sent by the transfer account, the search request is used for requesting to search the device identity bound to the transfer account, and receiving the device identity searched by these devices or servers according to the search request.

In addition to the above methods, there are other methods easily envisaged for the server in determining the device identity of the mobile device bound to the transfer account, which will not be limited in the embodiment.

Second, it is detected whether a physical characteristic sent together with the device identity of the mobile device is received within a predetermined time period. The reception time is fallen into the predetermined time period. The reception time can be an initial moment, an end moment or an intermediate moment of the predetermined time period.

In one case, the server may detect whether the physical characteristic sent together with the device identity of the mobile device is received within the predetermined time period with the reception time as the initial time. That is, the server, after receiving the resource transfer request, may detect whether the physical characteristic sent together with the device identity of the mobile device is received within the predetermined time period which starts from the reception time.

Alternatively, in another case, the server may detect whether the physical characteristic sent together with the device identity of the mobile device is received within the predetermined time period with the reception time as the end time. That is, the server, after receiving the resource transfer request, may detect whether the physical characteristic sent together with the device identity of the mobile device is received within the predetermined time period which ends by the reception time.

Alternatively, in yet another case, the server may detect whether the physical characteristic sent together with the device identity of the mobile device is received within the predetermined time period with the reception time as the median time. That is, the server, after receiving the resource transfer request, may detect whether the physical characteristic sent together with the device identity of the mobile device is received within the predetermined time period, for which the reception time is set as the median time.

Apparently, any predetermined time period that contains the reception time is applicable, which are not limited to the initial time, the end time or the median time. It is easily envisage that the predetermined time period may also be a time period with an end time earlier than the reception time, or the predetermined time period may also be a time period with an initial time later the reception time. The relationship between the reception time and the predetermined time period may be set according to the actual needs and should not be used to limit the protection scope of the present disclosure.

Generally speaking, the mobile device, after collecting the physical characteristic, may send the physical characteristic to the server. While sending the physical characteristic to the server, the mobile device also sends the device identity of the mobile device together with the physical characteristic so that the server can distinguish which mobile device sends the physical characteristic, herein the device identity is used to uniquely identify the mobile device.

In step 303, when the physical characteristic collected by the mobile device bound to the transfer account is received within the predetermined time period containing the reception time is detected, the resources are transferred when the physical characteristic matches with a stored physical characteristic model of the transfer account.

When detecting that the physical characteristic collected by the mobile device bound to the transfer account is received within the predetermined time period that includes the reception time, the server may calculate a matching degree between the physical characteristic and the stored physical characteristic model of the transfer account. When the calculated value of the matching degree is greater than a predetermined matching threshold, the physical characteristic is determined to match with the stored physical characteristic model of the transfer account.

The predetermined matching threshold may be set according to the actual situations, and the specific value of the predetermined matching threshold will not be limited in the embodiment. Generally, the greater the predetermined matching threshold is, the better the physical characteristic matches with the stored physical characteristic model of the transfer account when the calculated value of the matching degree is greater than the predetermined matching threshold.

When the physical characteristic matches with the stored physical characteristic model of the transfer account, it generally indicates that the resource transfer is relatively safe at this moment. In order to reduce the transfer complexity caused by various passwords (for instance, a transfer password, and a verification code) that is necessary in consideration of the security while transferring resources, the resources may be transferred in a simplified resource transfer flow. The simplified resource transfer flow herein refers to directly transferring the resources or transferring the resources by skipping verifications of at least one of the transfer password, a verification code and received dynamic information when transferring the resources.

That is, when the resource transfer flow usually requires verifications of the transfer password, the verification code, or the received dynamic information, the verifications of at least one or more of them may be skipped at this moment, and the steps that are not skipped are executed to complete the transferring of the resources. For instance, the resource transfer flow includes verifications of the transfer password and the verification code. If the verification of the verification code is skipped, then only the verification of the transfer password is required. After successful verification of the transfer password, the resources are transferred.

In step 304, when the physical characteristic does not match with the stored physical characteristic model of the transfer account, the resources are transferred using a default resource transfer flow, the default resource transfer flow at least including verification of the transfer password needed when transferring the resources.

The server calculates a matching degree between the physical characteristic and a stored physical characteristic model of the transfer account. When the calculated value of the matching degree is less than a predetermined matching threshold, then the physical characteristic is determined to not match with the stored physical characteristic model of the transfer account.

When the physical characteristic does not match with the stored physical characteristic model of the transfer account, it generally indicates that it is not safe to transfer the resources at this moment, for example, when an illegal user uses the mobile device of a legal user to request to transfer resources. At this moment, in order to ensure the security while transferring the resources, the default resource transfer flow may be used to transfer the resources, for instance, the default resource transfer flow at least including verification of the transfer password needed when transferring the resources.

Generally, according to the actual transfer demands, the default resource transfer flow may include verifying the verification code needed when transferring the resources, and the like.

In conclusion, according to the method for transferring resources provided in the embodiments, while receiving the transfer resource request of the transfer account, if detecting that the received physical characteristic matches with the physical characteristic model of the transfer account within the predetermined time period, the requested resources are transferred. Since the server may match the received physical characteristic with the physical characteristic model, and directly transfer the resources after successful matching, the problem of complex resource transfer flow caused by various passwords used for ensuring the resource transfer security during the resource transfer process is solved, and the effects of reducing the complexity of the resource transfer flow while ensuring the security is achieved.

According to the method for transferring resources provided in the embodiments, while receiving the transfer resource request of the transfer account, if detecting that the received physical characteristic does not match with the physical characteristic model of the transfer account within the predetermined time period, the resources are transferred using the default resource transfer flow. Since the default resource transfer flow further includes the process of verifying the transfer password while transferring the resources, the security of the transfer account while transferring the resources can be ensured.

Based on the embodiment as shown in FIG. 3A, in an optional implementation method, the server, when transferring the resources, may firstly binds the transfer account with the device identity of the mobile device set by the user, and then stores the binding relationship between the transfer account and the device identity bound to the transfer account. FIG. 3B is a flow chart of binding the transfer account to the device identity, according to an exemplary embodiment. As shown in FIG. 3B, the method for transferring resources may further include the following binding process.

In step b1, a setting command for binding the mobile device to the transfer account is received.

In practical application, the user may select a mobile device in use to bind with a transfer account in use. For instance, a terminal device used by the user may receive a device identity of the mobile device selected by the user, and send a setting command for binding the mobile device to the transfer account logged into by the user. Accordingly, the setting command of binding the mobile device to the transfer account may be received by the server.

Optionally, when the transfer account of the user is not bound to a mobile device, the server may send a binding recommendation to the transfer account to inform the user the mobile devices that can be bound, so as to shorten the flow while transferring resources.

In step b2, the device identity of the mobile device selected in the setting command is bound to the transfer account.

The server, after receiving the setting command for binding the mobile device to the transfer account, may bind the device identity of the mobile device selected in the setting command to the transfer account, and stores the binding relationship between the transfer account and the device identity.

Optionally, when the transfer account of the user is bound, the user may also cancel the binding relationship between one or more mobile devices and the transfer account. For instance, when a certain mobile device of the user bound to the transfer account is lost, in order to ensure the security of the transfer account and guarantee the precision of the physical characteristic model corresponding to the transfer account, the user may use the transfer account to send a binding cancellation request to the server. Herein the binding cancellation request carries a device identity of the mobile device whose binding relationship with the transfer account is to be cancelled. Accordingly, the sever, after receiving the binding cancellation request sent by the transfer account, may cancel the binding relationship between the transfer account and the mobile devices corresponding to the device identities carried in the binding cancellation request, and may also determine the device identity carried in the binding cancellation request as a device identity that was bound to the transfer account in the past.

In conclusion, according to the method for transferring resources provided in the embodiments, through binding the transfer account to the device identity and storing them, it can be determined whether or not to directly transfer the resources according to the physical characteristic associated with the bound device identity when receiving the resource transfer request sent by the transfer account. Thus, the verification flow while transferring resources is simplified.

In an optional implementation method, FIG. 3C shows a flow chart for establishing and updating a physical characteristic model, according to an exemplary embodiment. The method for transferring resources may also include the following steps.

In step c1, a physical characteristic collected by at least one mobile device bound to the transfer account is received.

Since the mobile device always sends both the collected physical characteristic and the device identity of the mobile device to the server together, the server may determine the device identity of the mobile device bound to the transfer account firstly, and then find the physical characteristic received together with the device identity according to the device identity, i.e., receive the physical characteristic collected by at least one mobile device bound to the transfer account.

In step c2, when no physical characteristic model of the transfer account is stored, a physical characteristic model of the transfer account is established by using the received physical characteristic.

When a physical characteristic model for the transfer account has not been established, the server may establish the physical characteristic model of the transfer account by using the received physical characteristic.

In step c3, when the physical characteristic model of the transfer account is stored, the physical characteristic model of the transfer account is corrected by using the received physical characteristic if the physical characteristic matches with the physical characteristic model.

When the server has already established the physical characteristic model for the transfer account, in order to improve the identifying precision of the physical characteristic model on the user of the transfer account, the physical characteristic model of the transfer account may further be corrected by using the received physical characteristic.

However, when the physical characteristic does not match with the physical characteristic model, it generally indicates that the mobile device of the physical characteristic is abnormal. In order to avoid interference on the physical characteristic model of the transfer account, the received physical characteristic may not be used to correct the physical characteristic model of the transfer account. Optionally, the server may save the abnormalities, so that the server may select different payment flows while transferring the resources corresponding to the transfer account in later stages according to these abnormalities.

In conclusion, the method for transferring resources according to embodiments of the present disclosure establishes the physical characteristic model for the transfer account by using the received physical characteristic collected by at least one mobile device bound to the transfer account, or, corrects the physical characteristic model of the transfer account by using the received physical characteristic when the physical characteristic model of the transfer account is stored and the physical characteristic matches with the physical characteristic model, and establishes the physical characteristic model according to the course of learning, and continuously updates and perfects the physical characteristic model, so that the physical characteristic model identifies the user corresponding to the transfer account more precisely and the resource transfer security is thus improved.

In an optional implementation manner, FIG. 3D shows a flow chart of abnormality prompting, according to an exemplary embodiment. The method for transferring resources may also include the following steps.

In step d1, whether an abnormality prompting condition is met is detected when receiving the physical characteristic sent by the mobile device bound to the transfer account.

The abnormality prompting condition includes that the acquired device identity sent together with the physical characteristic was bound to the transfer account in the past and is not bound to the transfer account currently, or, the physical characteristic sent by the mobile device bound to the transfer account is not received within a predetermined duration.

Since the mobile device, when sending the physical characteristic to the server, always sends both the collected physical characteristic and the device identity of the mobile device to the server together. The server, when receiving the physical characteristic, may obtain the device identity sent together with the physical characteristic. When the mobile device bound to the transfer account is lost, a legal user will usually cancel the binding between the mobile device and the transfer account to avoid the physical characteristic collected by the mobile device from continuously correcting the physical characteristic model of the transfer account of the user and causing inaccuracy of the physical characteristic model. Therefore, if the device identity of a certain mobile device was bound to an old transfer account in the past, but the binding to the transfer account is cancelled later later, then an abnormality condition is thought to happen when the physical characteristic sent by the mobile device is received again. That is, the abnormality prompting condition is met, and it is necessary to notify the user the abnormality.

In another case, when the physical characteristic sent by the mobile device bound to the transfer account is not received within a predetermined duration, it generally indicates that the mobile device is not connected for a long time, or the system of the mobile device is refreshed since the device identity of the mobile device may be probably refreshed when the system of the mobile device is refreshed. Therefore, the system cannot acquire or recognize the physical characteristic collected by the mobile device and thus cannot correct the physical characteristic model in real time. So an abnormality condition is thought to happen. That is, the abnormality prompting condition is met, and it is necessary to notify the user the abnormality.

In step d2, if the abnormality prompting condition is met, an abnormality prompt message is sent to the transfer account.

Optionally, the server, after sending the abnormality prompt message to the transfer account, may save the abnormality prompt message and record the saving moment. If a resource transfer request sent by the transfer account is received within a predetermined duration from the saving moment, then the resources are transferred using a default resource transfer flow, the default resource transfer flow at least including verification of the transfer password needed when transferring the resources, so as to ensure the resource transfer security.

Optionally, after sending the abnormality prompt message to the transfer account, if a resource transfer request is received subsequently, the resources requested to be transferred may be transferred using the default resource transfer flow in order to ensure the resource transfer security, the default resource transfer flow at least including verification of the transfer password needed when transferring the resources.

In conclusion, according to the method for transferring resources according to embodiments of the present disclosure, when the physical characteristic is received, the device identity sent together with the physical characteristic is obtained. The abnormality prompt message is sent to the transfer account when the device identity was bound to the transfer account in the past and is not bound to the transfer account currently. So the abnormality is notified to the user in time and thus the user experience and security is improved.

According to the method for transferring resources according to embodiments of the present disclosure, after the abnormality is sent to the transfer account, the resources are transferred using the default resource transfer flow if the resource transfer request sent by the transfer account is received within a predetermined duration to ensure the resource transfer security.

It should be additionally noted that the foregoing FIG. 3A may either be solely implemented as a method for transferring resources, or be implemented together with one, two or all of FIG. 3B, FIG. 3C and FIG. 3D as a method for transferring resources.

Embodiments of apparatus of the present disclosure are described hereinafter, which may be used for performing embodiments of methods of the present disclosure. For the details not described in the embodiments of apparatus of the present disclosure, please refer to the embodiments of methods of the present disclosure.

FIG. 4 is a block diagram of an apparatus for transferring resources, according to an exemplary embodiment. As shown in FIG. 4, the device for transferring resources is applied in the server 140 in the application scenario as shown in FIG. 1. The apparatus for transferring resources includes a first receiving module 402, a first detection module 404 and a first transfer module 406.

The first receiving module 402 is configured to receive a resource transfer request for transferring resources sent by means of a transfer account.

The first detection module 404 is configured to detect whether a physical characteristic collected by a mobile device bound to the transfer account is received.

The first transfer module 406 is configured to, when the first detection module 404 detects that the physical characteristic collected by the mobile device bound to the transfer account is received, transfer the resources when the physical characteristic matches with a stored physical characteristic model of the transfer account.

In conclusion, while receiving the transfer resource request for transferring recourses from the transfer account and detecting that the physical characteristic received matches with the physical characteristic model of the transfer account within the predetermined time period, the apparatus for transferring resources according to embodiments of the present disclosure then transfers the requested resources. Since the server may match the physical characteristic received with the physical characteristic model, and directly transfer the resources after successful matching, the problem of complex resource transfer flow caused by various passwords used for ensuring the resource transfer security during the resource transfer process is solved and the complexity of the resource transfer flow is reduced while ensuring the security.

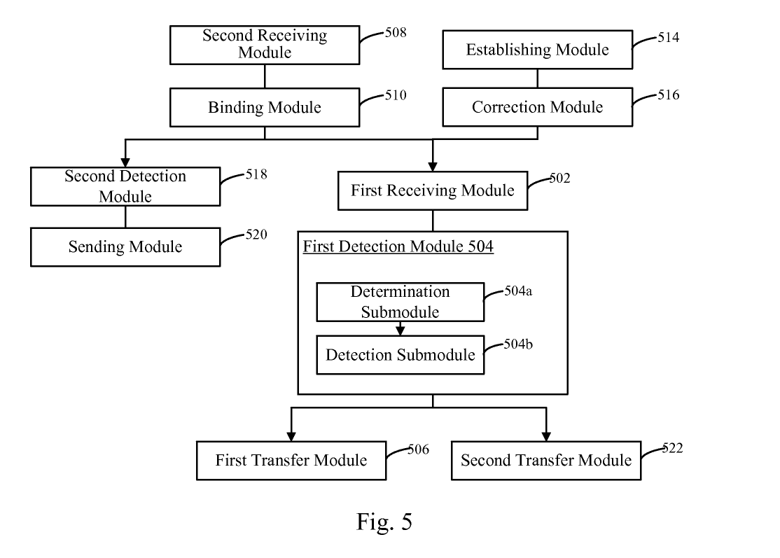

FIG. 5 is a block diagram of an apparatus for transferring resources, according to another exemplary embodiment. As shown in FIG. 5, the apparatus for transferring resources is applied in the server 140 in the application scenario as shown in FIG. 1. The apparatus for transferring resources includes a first receiving module 502, a first detection module 504 and a first transfer module 506.

The first receiving module 502 is configured to receive a resource transfer request of requesting to transfer resources sent by a transfer account.

The first detection module 504 is configured to detect whether a physical characteristic collected by a mobile device bound to the transfer account is received.

The first transfer module 506 is configured to, when the first detection module 504 detects that the physical characteristic collected by the mobile device bound to the transfer account is received, transfer the resources when the physical characteristic matches with a stored physical characteristic model of the transfer account.

In an optional implementation, the first detection module 504 may include: a determination submodule 504a and a detection submodule 504b.

The determination submodule 504a is configured to determine a reception time of receiving the resource transfer request.

The detection submodule 504b is configured to detect whether the physical characteristic collected by the mobile device bound to the transfer account is received within a predetermined time period that includes the reception time determined by the determination submodule 504a.

In an optional implementation, the apparatus for transferring resources may also include a second receiving module 508 and a binding module 510.

The second receiving module 508 is configured to receive a setting command of binding the mobile device to the transfer account.

The binding module 510 is configured to bind the device identity of the mobile device selected in the setting command received by the second receiving module 508 to the transfer account.

In an optional implementation, the apparatus for transferring resources may also include an establishing module 514 and a correction module 516.

The establishing module 514 is configured to, when the physical characteristic model of the transfer account is not stored, establish a physical characteristic model of the transfer account by using the received physical characteristic.

The correction module 516 is configured to, when the physical characteristic model of the transfer account is stored, correct the physical characteristic model of the transfer account by using the received physical characteristic if the physical characteristic matches with the physical characteristic model.

In an optional implementation, the apparatus for transferring resources may also include a second detection module 518 and a sending module 520.

The second detection module 518 is configured to detect whether an abnormality prompting condition is met when receiving the physical characteristic sent by the mobile device bound to the transfer account. The abnormality prompting condition includes that the acquired device identity sent together with the physical characteristic was bound to the transfer account in the past and is not bound to the transfer account currently, or, the physical characteristic sent by the mobile device bound to the transfer account is not received within a predetermined duration.

The sending module 520 is configured to send an abnormality prompt message to the transfer account when the second detection module 518 detects the abnormality prompting condition is met.

In an optional implementation, the first transfer module 506 may also be configured to: transfer the resources according to a simplified resource transfer flow, the simplified resource transfer flow being to directly transfer the resources, or being to transfer the resources by skipping at least one of verifications of a transfer password, a verification code or received dynamic information needed when transferring the resources.

In an optional implementation, the apparatus for transferring resources may also include: a second transfer module 522.

The second transfer module 522 is configured to transfer the resources using a default resource transfer flow when the physical characteristic does not match with the stored physical characteristic model of the transfer account, the default resource transfer flow at least including verification of the transfer password required when transferring the resources.

In conclusion, while receiving the transfer resource request for transferring recourses from the transfer account and detecting that the received physical characteristic matches with the physical characteristic model of the transfer account within the predetermined time period, the apparatus for transferring resources according to embodiments of the present disclosure then transfers the requested resources. Since the server may match the physical characteristic received with the physical characteristic model, and directly transfer the resources after successful matching, the problem of complex resource transfer flow caused by various passwords used for ensuring the resource transfer security during the resource transfer process is solved and the complexity of the resource transfer flow is reduced while ensuring the security.

While receiving the transfer resource request for transferring recourses from the transfer account and detecting that the physical characteristic received does not match with the physical characteristic model of the transfer account within the predetermined time period, the apparatus for transferring resources according to embodiments of the present disclosure then transfers the resources using the default resource transfer flow. Since the default resource transfer flow further includes the process of verifying the transfer password while transferring resources, the security of the transfer account while transferring resources can be ensured.

By binding the transfer account with the device identity and storing the physical characteristic associated with the bound device identity, the apparatus for transferring resources according to embodiments of the present disclosure may determine whether or not to directly transfer the resources according to the physical characteristic associated with the bound device identity when receiving the resource transfer request sent by the transfer account. Thus the verification flow is simplified while transferring the resources.

The apparatus for transferring resources according to embodiments of the present disclosure establishes the physical characteristic model for the transfer account by using the received physical characteristic collected by at least one mobile device bound to the transfer account, or, corrects the physical characteristic model of the transfer account by using the received physical characteristic when the physical characteristic model of the transfer account is stored and the physical characteristic matches with the physical characteristic model, establishes the physical characteristic model by the course of learning, and continuously updates and perfects the physical characteristic model, so that the physical characteristic model identifies the user corresponding to the transfer account more precisely. Thus, the resource transfer security is improved.

The apparatus for transferring resources according to embodiments of the present disclosure, when receiving the physical characteristic, acquires the device identity sent together with the physical characteristic, and sends the abnormality prompt message to the transfer account when the device identity was bound to the transfer account in the past and is not bound to the transfer account currently. Thus, the abnormality is notified to the user in time and the user experience and security is improved.

With respect to the apparatus in the above embodiments, the specific methods for performing operations for individual modules have been described in detail in the embodiments regarding the methods, which will not be elaborated here.

According to an exemplary embodiment of the present disclosure, there is provided a device for transferring resources, which is applied in a server 140 in an application scenario as shown in FIG. 1, and may be used to implement the method for transferring resources according to the present disclosure. The device for transferring resources includes: a processor and a memory for storing instructions executable by the processor. The processor is configured to: receive a resource transfer request of requesting to transfer resources sent by a transfer account, and record a reception time; detect whether a physical characteristic collected by a mobile device bound to the transfer account is received within a predetermined time period containing the reception time; and when detecting that the physical characteristic collected by the mobile device bound to the transfer account is received within the predetermined time period containing the reception time, transfer the resources when the physical characteristic matches with a stored physical characteristic model of the transfer account.

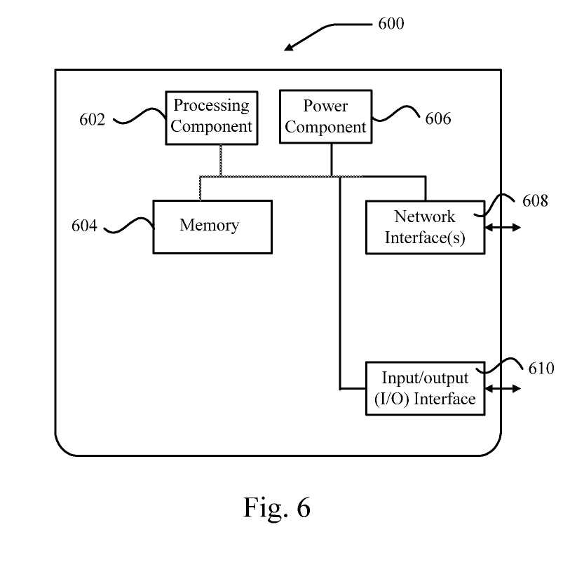

FIG. 6 is a block diagram of an apparatus for transferring resources, according to an exemplary embodiment. For example, the device 600 may be provided as a server. Referring to FIG. 6, the device 600 includes a processing component 602 that further includes one or more processors, and memory resources represented by a memory 604 for storing instructions executable by the processing component 602, such as application programs. The application programs stored in the memory 604 may include one or more modules each corresponding to a set of instructions. Further, the processing component 602 is configured to execute the instructions to perform the above method for transferring resources.

The device 600 may also include a power component 606 configured to perform power management of the device 600, wired or wireless network interface(s) 608 configured to connect the device 600 to a network, and an input/output (I/O) interface 610. The device 600 may operate based on an operating system stored in the memory 604, such as Windows Server™, Mac OS X™, Unix™, Linux™, FreeBSD™, or the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for transferring resources, comprising:
receiving a resource transfer request for transferring resources sent by means of a transfer account;
detecting whether a physical characteristic collected by a mobile device bound to the transfer account is received; and
if detecting that the physical characteristic collected by the mobile device bound to the transfer account is received, transferring the resources when the physical characteristic matches with a stored physical characteristic model of the transfer account.

2. The method according to claim 1, wherein detecting whether the physical characteristic collected by the mobile device bound to the transfer account is received comprises:
determining a reception time at a moment when receiving the resource transfer request; and
detecting whether the physical characteristic collected by the mobile device bound to the transfer account is received within a predetermined time period containing the reception time.

3. The method according to claim 1, further comprising:
receiving a setting command for binding the mobile device to the transfer account, wherein the setting command comprises a device identity of the terminal device; and
binding the device identity of the mobile device to the transfer account.

4. The method according to claim 1, further comprising:
when no physical characteristic model of the transfer account is stored, establishing a physical characteristic model of the transfer account by using the received physical characteristic; and
when the physical characteristic model of the transfer account is stored, correcting the physical characteristic model of the transfer account by using the received physical characteristic if the physical characteristic matches with the physical characteristic model.

5. The method according to claim 1, further comprising:
detecting whether an abnormality prompting condition is met when receiving the physical characteristic sent by the mobile device bound to the transfer account, wherein the abnormality prompting condition requires that the acquired device identity sent together with the physical characteristic was bound to the transfer account in the past and is not bound to the transfer account currently, or, no physical characteristic sent by the mobile device bound to the transfer account is received within a predetermined duration; and
if the abnormality prompting condition is met, sending an abnormality prompt message to the transfer account.

6. The method according to claim 1, wherein transferring the resources comprises:
transferring the resources according to a simplified resource transfer flow, wherein the simplified resource transfer flow comprises directly transferring the resources, or transferring the resources by skipping verifications of at least one of a transfer password, a verification code and received dynamic information when transferring the resources.

7. The method according to claim 1, further comprising:
transferring the resources using a default resource transfer flow when the physical characteristic does not match with the stored physical characteristic model of the transfer account, wherein the default resource transfer flow at least comprises verifying a transfer password required when transferring the resources.

8. The method according to claim 2, further comprising:
transferring the resources using a default resource transfer flow when the physical characteristic does not match with the stored physical characteristic model of the transfer account, wherein the default resource transfer flow at least comprises verifying a transfer password required when transferring the resources.

9. The method according to claim 3, further comprising:
transferring the resources using a default resource transfer flow when the physical characteristic does not match with the stored physical characteristic model of the transfer account, wherein the default resource transfer flow at least comprises verifying a transfer password required when transferring the resources.

10. The method according to claim 4, further comprising:
transferring the resources using a default resource transfer flow when the physical characteristic does not match with the stored physical characteristic model of the transfer account, wherein the default resource transfer flow at least comprises verifying a transfer password required when transferring the resources.

11. The method according to claim 5, further comprising:
transferring the resources using a default resource transfer flow when the physical characteristic does not match with the stored physical characteristic model of the transfer account, wherein the default resource transfer flow at least comprises verifying a transfer password required when transferring the resources.

12. The method according to claim 6, further comprising:
transferring the resources using a default resource transfer flow when the physical characteristic does not match with the stored physical characteristic model of the transfer account, wherein the default resource transfer flow at least comprises verifying a transfer password required when transferring the resources.

13. A device for transferring resources, comprising:
a processor; and
a memory for storing instructions executable by the processor;
wherein the processor is configured to perform:
receiving a resource transfer request for transferring resources sent by means of a transfer account;
detecting whether a physical characteristic collected by a mobile device bound to the transfer account is received; and
if detecting that the physical characteristic collected by the mobile device bound to the transfer account is received, transferring the resources when the physical characteristic matches with a stored physical characteristic model of the transfer account.

14. The device according to claim 13, wherein the processor is further configured to perform:
determining a reception time at a moment when receiving the resource transfer request; and
detecting whether the physical characteristic collected by the terminal device bound to the transfer account is received within a predetermined time period containing the reception time.

15. The device according to claim 13, wherein the processor is further configured to perform:
receiving a setting command for binding the mobile device to the transfer account, wherein the setting command comprises a device identity of the mobile device; and
binding the device identity of the mobile device to the transfer account.

16. The device according to claim 13, wherein the processor is further configured to perform:
when no physical characteristic model of the transfer account is stored, establishing a physical characteristic model of the transfer account by using the received physical characteristic; and
when the physical characteristic model of the transfer account is stored, correcting the physical characteristic model of the transfer account by using the received physical characteristic if the physical characteristic matches with the physical characteristic model.

17. The device according to claim 13, wherein the processor is further configured to perform:
detecting whether an abnormality prompting condition is met when receiving the physical characteristic sent by the mobile device bound to the transfer account, wherein the abnormality prompting condition requires that the acquired device identity sent together with the physical characteristic was bound to the transfer account in the past and is not bound to the transfer account currently, or, no physical characteristic sent by the mobile device bound to the transfer account is received within a predetermined duration; and
if the abnormality prompting condition is met, sending an abnormality prompt message to the transfer account.

18. The device according to claim 13, wherein the processor is further configured to perform:
transferring the resources according to a simplified resource transfer flow, wherein the simplified resource transfer flow comprises directly transferring the resources, or transferring the resources by skipping at least one of the required verification means of a transfer password, a verification code and received dynamic information when transferring the resources.

19. The device according to claim 13, wherein the processor is further configured to perform:
transferring the resources using a default resource transfer flow when the physical characteristic does not match with the stored physical characteristic model of the transfer account, wherein the default resource transfer flow at least comprises verifying a transfer password required when transferring the resources.

20. A non-transitory readable storage medium comprising instructions, executable by a processor in a device, for performing a method for transferring resources, the method comprising:
receiving a resource transfer request of requesting to transfer resources sent by means of a transfer account;
detecting whether a physical characteristic collected by a mobile device bound to the transfer account is received; and
if detecting that the physical characteristic collected by the mobile device bound to the transfer account is received, transferring the resources when the physical characteristic matches with a stored physical characteristic model of the transfer account.
